(19) United States
(12) Patent Application Publication
(10) Pub. No.: US 2012/0041827 A1
(43) Pub. Date: Feb. 16, 2012

(54) Demand Driven Avails

(75) Inventors: Randall B. Laughlin, Carlisle, MA (US); Lisa L. Lutz, Sudbury, WA (US); Darren R. Wetzel, Boston, MA (US)

(73) Assignee: MICROSOFT CORPORATION, Redmond, WA (US)

(21) Appl. No.: 12/856,036

(22) Filed: Aug. 13, 2010

(51) Int. Cl. G06Q 30/00

(52) U.S. Cl. 705/14.71

(57) ABSTRACT

Various embodiments enable demand driven allocation of advertisement insertion opportunities, e.g., avails, that are associated with television content or other media entertainment from a provider. In at least some embodiments, projections for an inventory of avails from a provider are obtained using an iterative projection model. Auctions are conducted using the projected inventory to allocate the avails to advertisers using bids from the advertisers. Offers to purchase avails from the providers can be formed based on these auctions and submitted to the provider on behalf of the advertisers. Based on a response from the provider to these offers, yield analysis can be performed to update the projection model to reflect results of the submitted offers. Projections for subsequent iterations can then make use of the updated projection model.

### BACKGROUND

Content distributed by a network operator to clients, including satellite radio, streaming media over the Internet, digital cable television programming, over-the-air programming, and so on can be configured to contain advertisement insertion opportunities that are referred to as “avails.” Traditionally, avails are allocated using a predetermined inventory of avails from providers in a supply driven model. One problem with this supply driven approach is that the supply side focus may not accurately account for actual demand, and therefore providers may be deprived of opportunities to manage inventory effectively in accordance with the demand. Accordingly efficient management and allocation of inventory from providers can be quite difficult using traditional techniques.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable demand driven allocation of advertisement insertion opportunities, e.g., avails, that are associated with television content or other media entertainment from a provider. In at least some embodiments, projections for an inventory of avails from a provider are obtained using an iterative projection model. Auctions are conducted using the projected inventory to allocate the avails to advertisers using bids from the advertisers. Offers to purchase avails from the providers can be formed based on these auctions and submitted to the provider on behalf of the advertisers. Based on a response from the providers to these offers, yield analysis can be performed to update the projection model to reflect results of the submitted offers. Projections for subsequent iterations can then make use of the updated projection model.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example operating environment that is operable to employ techniques for demand driven avails in one or more embodiments.

FIG. 2 is a flow diagram depicting an example procedure in accordance with one or more embodiments.

FIG. 3 is another flow diagram depicting an example procedure in accordance with one or more embodiments.

FIG. 4 is an illustration of an example system that can be used to implement one or more embodiments.

### DETAILED DESCRIPTION

Overview

Various embodiments enable demand driven allocation of advertisement insertion opportunities, e.g., avails, that are associated with television content or other media entertainment from a provider. In at least some embodiments, projections for an inventory of avails from a provider are obtained using an iterative projection model. Auctions are conducted using the projected inventory to allocate the avails to advertisers using bids from the advertisers. Offers to purchase avails from the providers can be formed based on these auctions and submitted to the provider on behalf of the advertisers. Based on a response from the provider to these offers, yield analysis can be performed to update the projection model to reflect results of the submitted offers. Projections for subsequent iterations can then make use of the updated projection model. Iterations can be periodically performed at a designated time interval and for a corresponding time period (e.g., day, week, month, etc.) to update the projection model and then the updated projection model can be used to allocate avails to advertisers for the next time period. Iterative projections used to allocate avails can also be made individually for each of a plurality of providers.

In the discussion that follows, a section entitled “Operating Environment” describes but one environment in which various embodiments of demand driven avails can be employed. Following this, a section entitled “Example Procedures” describes example techniques for demand driven avails. Last, a section entitled “Example System” is provided and describes an example system that can be used to implement one or more embodiments.

Operating Environment

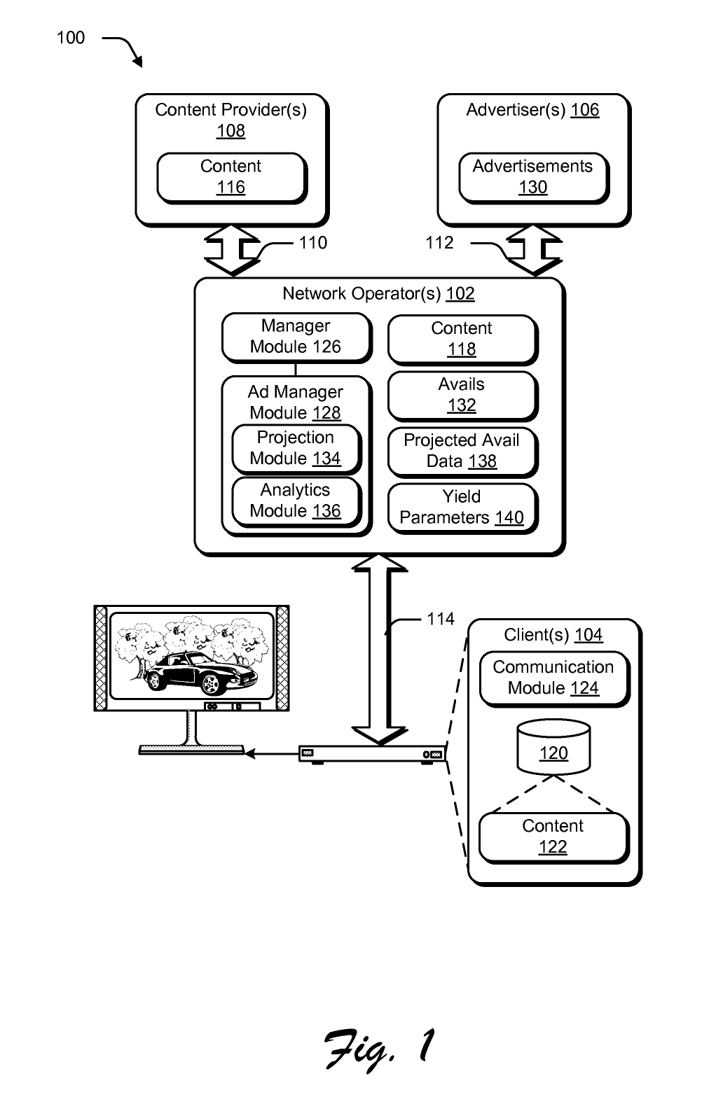

FIG. 1 is an illustration of an example operating environment 100 that is operable to employ techniques for demand driven avails. The illustrated environment 100 includes a network operator 102 (e.g., a “head end” or “distribution server”), a client 104, an advertiser 106 and a content provider 108 that are communicatively coupled, one to another, via network connections 110, 112, 114. Although a plurality of network connections 110-114 are shown separately, the network connections 110-114 may be representative of network connections achieved using a single network or multiple networks. Further network connections 110-114 can be made by way of various types of networks including but not limited to the Internet, over-the-air (OTA), a cellular network, a satellite network, and/or a television broadcast network, to name a few.

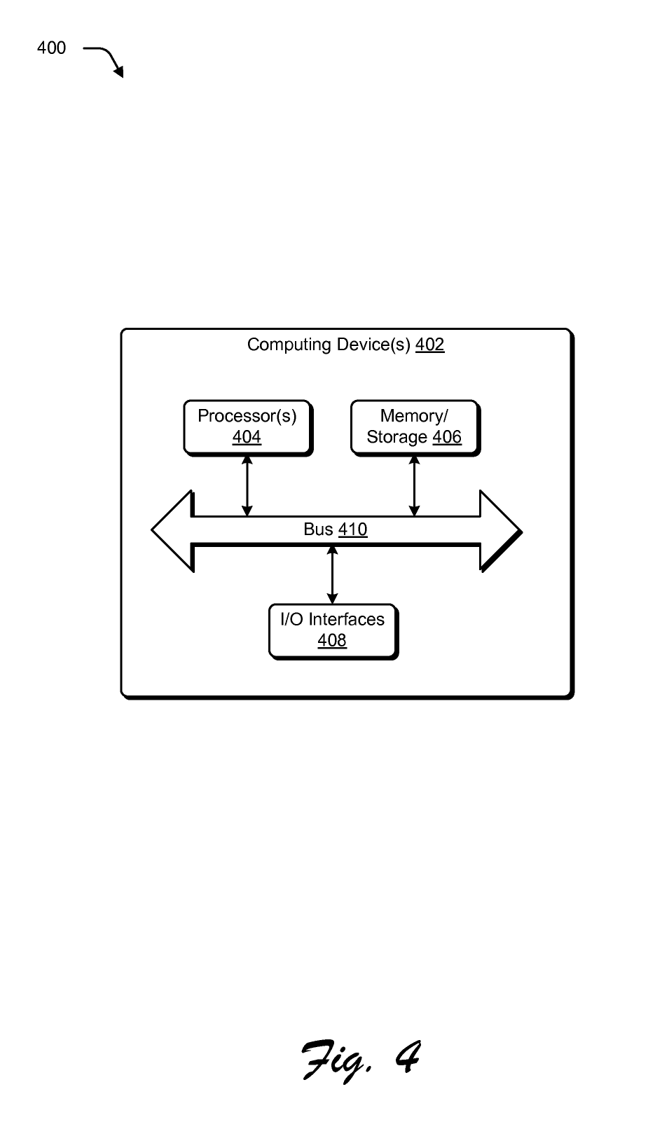

The network operator 102, the client 104, the advertiser 106 and the content provider 108 can each be implemented by way of one or more computing devices having respective processors, memories, storage, and/or other hardware and software components typically associated with various computing devices. One particular example of a computing device is shown and described in relation to FIG. 4 herein. In the following discussion, the network operator 102, the client 104, the advertiser 106 and the content provider 108 may be representative of one or more entities, and therefore reference may be made to a single entity (e.g., the client 104) or multiple entities (e.g., the clients 104, the plurality of clients 104, and so on).

The client 104 can be configured in a variety of ways. For example, the client 104 may be configured as a computer that is capable of communicating over the network connection 114, such as a desktop computer, a mobile station, an entertainment appliance, a set-top box communicatively coupled to a display device as illustrated, a wireless phone, and so forth. Thus, the client 104 may range from a full resource device with substantial memory and processor resources (e.g., television-enabled personal computers, television recorders equipped with hard disk) to a low-resource device with limited memory and/or processing resources (e.g., traditional set-top boxes, a television set). The client 104 can also include one or more antennas for receiving signals and/or content broadcast over-the-air (OTA). For purposes of the following discussion, the client 104 may also relate to a person and/or entity that operate the client. In other words, client 104 may describe a logical client that includes a user, software and/or a machine.

The content provider 108 includes one or more items of content 116. The content 116 can be communicated over the network connection 110 to the network operator 102. Content 116 communicated via the network connection 110 can be received by the network operator 102 and stored as one or more items of content 118.

Content 116 and content 118 that is described herein may include a variety of data, such as television programming, video-on-demand (VOD) files, one or more results of remote application processing, content recorded by the network operator 102 in response to a request from the client 104 in a network DVR example, and so on. The content 118 may be the same as or different from the content 116 received from the content provider 108. The content 118, for instance, may include additional data for broadcast to the client 104, such as (EPG) data from an EPG database.

Distribution of content 118 from the network operator 102 to the client 104 may be accommodated in a number of ways, including cable, radio frequency (RF), microwave, digital subscriber line (DSL), over-the-air (OTA) delivery, Internet based delivery, and satellite. The client 104 typically includes hardware and software to transport and decrypt content 118 received from the network operator 102 for rendering by the illustrated display device. Although a display device is shown, a variety of other output devices are also contemplated, such as speakers.

The client 104 can also include digital video recorder (DVR) functionality. For instance, the client 104 may include a storage device 120 to record content 118 as content 122 received via the network connection 114 for output to and rendering by the display device. The client 104 further includes a communication module 124 that is executable on the client 104 to control content playback on the client 104, such as through the use of one or more “command modes.” The command modes may provide non-linear playback of the content 122 (e.g., time shift the playback of the content 122) such as pause, rewind, fast forward, slow motion playback, and the like.

The network operator 102 is illustrated as including a manager module 126. The manager module 126 is representative of functionality to configure content 118 for output (e.g., streaming) over the network connection 114 to the client 104. The manager module 126, for instance, can configure content 116 received from the content provider 108 to be suitable for transmission over the network connection 114, such as to “packetize” the content for distribution over the Internet, configuration for a particular broadcast channel, and so on.

Thus, in the environment 100 of FIG. 1, the content provider 108 can broadcast the content 116 over a network connection 110 to a multiplicity of network operators, an example of which is illustrated as network operator 102. The network operator 102 may then stream the content 118 over a network connection to a multitude of clients, an example of which is illustrated as client 104. The client 104 can then store the content 118 in the storage device 120 as content 122, such as when the client 104 is configured to include digital video recorder (DVR) functionality. Regardless of the source, the content can provide a variety of opportunities in which to insert advertisements.

Accordingly, demand driven techniques are described herein that can be employed to allocate advertisement insertion opportunities to advertisers 106. For example, the network operator 102 may include or otherwise make use of an ad manager module 128 that is representative of functionality to implement an ad management system. The ad management system can provide ad auctions, such as to auction opportunities to output advertisements 130 from advertisers 106 in conjunction with content. Although the ad manager module 128 is depicted as a part of the network operator 102, ad management may be provided in a variety of ways, such as through use of a third-party ad management service apart from the network operator 102, as a separate ad management system, as a part of a content provider 108, and so on.

Various content that is described herein can include or otherwise be associated with various advertisement insertion opportunities or “avails” at which advertisements can be inserted into the content or otherwise be shown when the content is output via a client 104. The network operator 102 is illustrated as having avails 132 that are representative of various advertisement insertion opportunities that can be associated with content in any suitable way.

For example, avails 132 can occur at the start of a television or other media program, during a break in an output of a program, between programs, after output of a program, and so forth. Further, avails 132 can occur in conjunction with content 122 that is local to the client 104, content 118 that is broadcast, and/or content 118 that is time-shifted, such as in the network DVR example discussed above.

To implement demand driven auctions for the avails 132, ad manager module 128 can be configured to include or otherwise make use of a projection module 134 and/or an analytics module 136. Although projection module 134 and analytics module 136 are depicted as components of the ad manager module 128, it is noted that various modules and functionality described herein can be implemented in any suitable way using various combinations of hardware and/or software. It is also contemplated that modules and functionality described herein can be further combined and/or divided into one or more components, devices, sub-components, and the like. Thus, the example arrangement of various components illustrated in the example operating environment 100 should not be construed as limiting.

The projection module 134 is representative of functionality to obtain projections for avails that may be purchased from one or more content providers 108. The projection module 134 can be configured to implement an iterative projection model to produce the projections that are represented by projected avail data 138.

Ad manager module 128 can then make use of the projected avail data 138 to conduct auctions to allocate advertisements 130 to projected avails. Based on the auctions, ad manager module 128 can form and/or submit offers to buy avails 132 to the one or more content providers 108. The content providers 108 provide responses such as to accept, reject, modify, or otherwise take action upon the submitted offers.

The analytics module 136 is representative of functionality to perform various analysis to process data related to the auctions, avails, offers, and/or responses to offers. For example, analytics module 136 can operate to iteratively calculate, manage, and update various yield parameters 140 that are employed to inform the projection model. By way of example, the yield parameters 140 can include parameters indicative of pricing, availability, avail duration, allocation statistics, and so forth. Thus, analysis performed by the analytics module 136 provides feedback that can be used by the projection module 134 to make updated projections. In this manner, projected avails can be employed to derive offers to buy avails that are demand driven. Rather than attempting to allocate a pre-determined supply of avails 132 to advertisers (e.g., supply driven), auctions using projected avail data 138 are based on actual demand for avails 132 and can be employed to make offers to providers in accordance with the demand (e.g., demand driven).

Having considered an example operating environment, consider now a discussion of example procedures that can be employed in one or more embodiments of demand driven avails.

Example Procedures

The following discussion describes example techniques for demand driven avails that may be implemented utilizing the previously described environment, systems, and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the example operating environment 100 of FIG. 1.

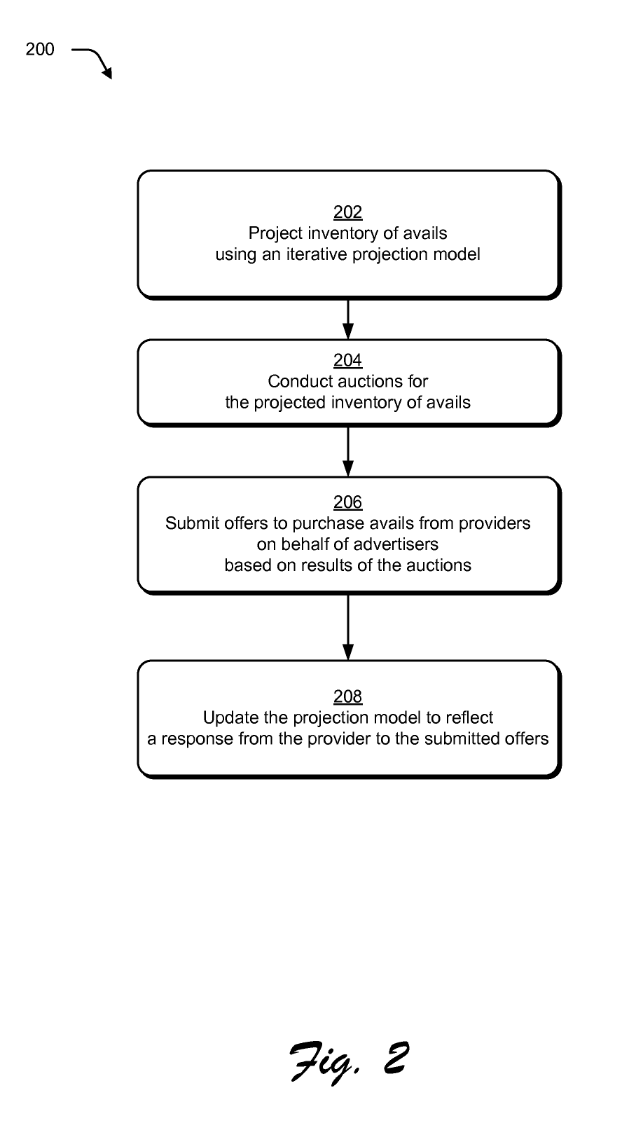

FIG. 2 is a flow diagram that describes an example procedure 200 in accordance with one or more embodiments. In at least some embodiments, the procedure 200 can be performed by a suitably configured computing device, such as a network operator 102 of FIG. 1, or other computing device having an ad manager module 128.

Step 202 projects inventory of avails using an iterative projection model. For example, projection module 134 can be implemented to calculate or otherwise obtain projections of avails 132 (e.g., available ad insertion opportunities) corresponding to one or more content providers 108. Initially, historic avail data regarding inventory from a provider can be used to make an educated guess as to the available inventory. For example, a network operator 102 can manage a historic avail database having data indicative of historic transactions to allocate avails to advertisers. The historic avail data can include information regarding avail pricing, availability, characteristics of avails (duration, content type, day/time, channel), and so forth for one or more providers. Accordingly, the projection module 134 can reference historic avail data that is collected and/or managed by the network operator 102 to make projections for one or more providers.

Subsequently, feedback can be obtained and used to update the projection model for future projections. This can involve updating the projection model in accordance with various yield parameters 140 as discussed in greater detail below. In at least some embodiments, the projections are made individually for each provider. Projections can also be made at periodic intervals for a designated time period such as daily, weekly, monthly, and so forth. For example, projections can be made iteratively each day (or other designated time interval) for a provider, allocation of avails for the next day (or other time period) can occur through auctions and offers to buy as described herein, and then results of the allocation can be used to update the projection model for subsequent projections and allocations.

In general, projection module 134 is configured to implement a projection model that is adaptable, reflects actual avail transactions, and is updated dynamically. To do so, the projection model can combine historic data with feedback information obtained through iterative projections and allocations. For instance, projection model can be configured to incorporate a variety of yield parameters 140 that can be computed by analytics module 136 to make projections. The yield parameters can include one or more parameters that are indicative of pricing and availability. The yield parameters can also include parameters that are indicative of one or more of time of day constraints, program characteristics, calendar events, special events, viewership constraints, placement constraints, and/or adjacency constraints.

In one example the projection model is implemented using a probability formula that accounts for various yield parameters to predict avails that a provider is likely to have to sell for a given time period (e.g., day, week, month, etc.). In at least some embodiments, this can involve determining potential avails for the time period using historic avail data and trends, calculating probabilities for the potential avails based on the probability formula, and selecting a projected set of avails based on the calculated probabilities. For instance, an avail can be selected for inclusion in the projected set of avails when the calculated probability associated with the avail meets or exceeds a configurable threshold probability value (e.g., 80%, 90%, etc.). Avails associated with probabilities lower than the configurable threshold can be discarded.

A probability formula that accounts for various yield parameters can be configured in any suitable way. By way of example and not limitation, an example format for a suitable probability formula can be expressed as follows:

P=W₁Y₁+W₂Y₂+ . . . W_{N}Y_{N}

In the above expression, any number “n” (where n can be an integer from 1 to N) of yield parameters Y can be used to compute the probability P. Specifically, P can be computed by summing values WₙYₙ that represent the value for a particular yield parameter Yₙ multiplied by a weight factor Wₙ. Naturally, a variety of different probability formulas can be constructed that employ different parameters and/or other considerations in different combinations.

Thus, projection module 134 can operate to obtain projections of avails for providers that can then be used to allocate the avails to advertisers. In particular, step 204 conducts auctions for the projected inventory of avails. For instance, given the projected inventory, ad manger module 128 can use bids from advertisers 106 to allocate projected avails to the advertisers 106. The auctions are configured to match avails to advertisers using various criteria to determine “winners.” In other words, placement objectives associated with bids are matched to characteristics associated with the projected avails.

Bids to be submitted to the network operator 102 by an advertiser 106 can be formed in a variety of ways. Generally, advertisers 106 can interact with an ad management system to place orders or “media buys” using the various criteria to designate placement objectives (e.g., quantity, price, target audience, constraints, and so forth) for corresponding ads. Media buys and/or corresponding bids can be communicated between advertisers and an ad management system in any suitable way. One way this can occur is through a bid entry interface that is exposed via the ad manager module 128. The bid entry interface can be accessible over a network by way of a browser, and/or other suitable application of an advertiser 106.

By way of example and not limitation, bids can include budget and impression criteria for an ad/campaign, audience targeting criteria, content selection criteria, scheduling criteria, and/or other types of criteria that can be used to specify placement of advertisements 130 from advertisers 106. Budget and impression criteria can be configured to designate price and quantity aspects of a media buy such as a number of impressions, an overall budget, maximum price, average price per impression, and so forth. Audience targeting criteria defines characteristics and/or behaviors of an audience that is targeted by the media buy including for example viewer profile and demographics, selected client favorite information, viewer geographic or market location information (e.g., state, city, zip code), client device capabilities (e.g., pay per view access, high definition, internet connection, device resolution), viewing history and patterns, and so forth. Content selection criteria relates to the kind of content targeted by the media buy including for example program categories, program ratings, keywords, actor selections, intended/expected audience information (e.g., child, family, age of viewer, male or female), etc.

Scheduling criteria relates to when and how often an advertiser would like an advertisement to be placed. For instance, scheduling criteria can include time and/or day constraints, program schedules, selection of particular channels or networks, live or time-shifted placement, and segment duration to name a few. Scheduling criteria can also include adjacency constraints that can control the frequency for an ad and/or the kinds of other ads that are shown within the same ad block, program, or time period. Examples of such adjacency constraints include constraints on frequency of ad placement within a day, program or time block, placement of an ad within a program category, placement of an ad with ads of a similar type or product, and placement of the ad with other ads from the same advertiser, to name a few.

A number of media buys associated with one or more ads can be combined to create an ad campaign. Placement objectives for a media buy can be quite specific. For instance, an example media buy can be placed to order 10,000 impressions of a particular ad (e.g., views of the ad by viewers) at a maximum cost of $5 CPM (e.g., $5 per thousand impressions), during sports programs airing on weekends or after 5:00 PM on weekdays. Avails 132 can also be associated with various characteristics that can be matched one to another to placement objectives associated with bids and/or ads. In this context, a bid can be considered as an application of a particular media buy to a particular avail based on the placement objectives and characteristics of the avail.

Thus, advertisers 106 can input individual bids, media buys, ad campaigns, and the like. The ad manager module 128 can use actual bids from advertisers to conduct auctions to match the bids to projected avails based on the placement objectives and characteristics of the avail. Additionally or alternatively, historic bid data can be compiled and used to produce projected bids in a manner comparable to producing projected avails. For example, the ad manager module 128 can collect and store data related to bids from the advertisers 106 as historic bid data. This historic bid data can then be examined or otherwise processed to derive projected bids that are suitable for an auction involving a projected avail. Thus, actual and/or projected bids can be used in conjunction with demand driven avail techniques described herein.

Step 206 submits offers to purchase avails from providers on behalf of advertisers based on results of the auctions. In particular, offers can be formed and submitted on behalf of the “winners” determined through the auctions in step 204. Offers can be submitted in any suitable way using various communication techniques, such as email, instant messaging, posted offer messages, a data file, web based interactions over the internet, and the like. For instance, individual offers can be formed for each winning bid. The offers can be communicated to a provider by way of a single communication or individually for each offer. A provider that receives the offers can process the offers, such as to accept or reject the offers. The provider can then send one or more responses to the network operator 102 that include indications of the accepted and rejected offers.

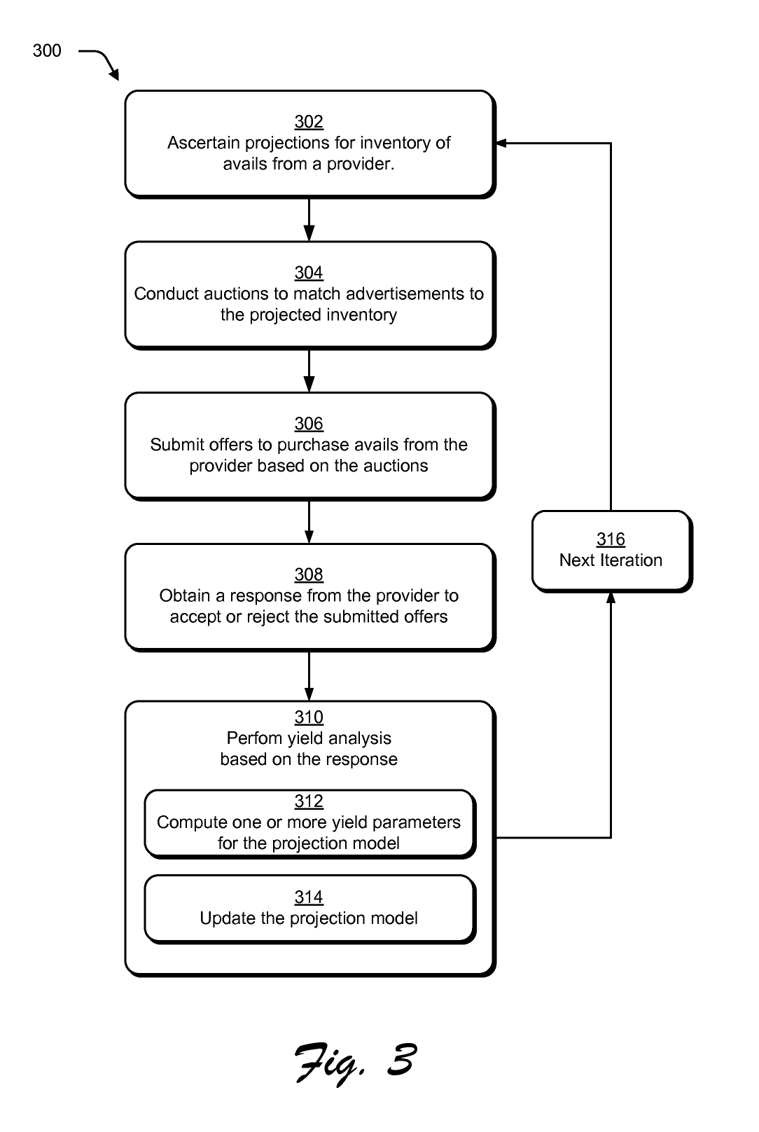

Step 208 updates the projection model to reflect a response from the provider to the submitted offers. For instance, analytics module 136 can be implemented to analyze responses from providers in various ways. This enables the analytics module to compute and/or update various yield parameters 140. Projection module 134 can then make use of the yield parameters 140 to modify the projection model accordingly. In this manner the projection model is updated dynamically to reflect actual avail transactions for a given time period so that projections for avails can be made for the next time period. Additional details regarding these and other aspects of demand driven avail techniques can be found in the discussion of FIG. 3 just below.

FIG. 3 is a flow diagram that describes an example procedure 300 in accordance with one or more embodiments. In at least some embodiments, the procedure 300 can be performed by a suitably configured computing device, such as a network operator 102 of FIG. 1, or other computing device having an ad manager module 128.

Step 302 ascertains projections for the inventory of avails from a provider. For example, an ad manager module 128 can include functionality to make projections for a provider at a periodic time interval in the manner described above in relation to FIG. 2. Using the ascertained projections, step 304 conducts auction to match advertisements to the projected inventory. For instance, ad manager module 128 can make use of actual or projected bids to conduct auctions for projected avails that are determined in step 302. The auctions are conducted to determine “winners” by matching placement objectives of the bids to characteristics of the projected avails. The “winners” can also be selected based at least in part upon pricing, budget, and revenue goals.

Having identified the “winners,” step 306 submits offers to purchase avails from the provider. In particular, ad manager module 128 can be configured to ascertain the winners of the auctions conducted in step 304, form one or more corresponding offers on behalf of the winners, and communicate the offers to the provider in any suitable manner.

Step 308 obtains a response from the provider to accept or reject the submitted offers. The response from a provider can be configured in any suitable manner using various communication techniques, such as email, instant messaging, posted response messages, a data file, web based interactions over the internet, and the like. A response can be, but need not be, configured in a format comparable to the submitted offers.

In general, the response that is obtained indicates whether particular offers were accepted or rejected. In at least some embodiments, ad manager module 128 can be configured to support other actions on offers such as counter offers, a request for more information, and initiation of an interactive session between buyer and seller to complete a transaction, to name a few examples.

For rejected offers, a response can also be configured to include one or more reject codes that are indicative of reasons why the offer was rejected. Various reject codes can be used to indicate different reasons why an offer was rejected including too low of a price, no availability, better offer accepted, placement objective constraints not met, and/or provider constraints not met, to name a few examples. The reject codes can be configured using numeric codes or other suitable identifiers that can be incorporated into responses from providers. Ad manager module 128 can also be configured to “roll back” rejected offers as the corresponding bids for these offers that won the auctions did not get placed with actual avails. This roll back can involve restoring the bids by setting the status of the bids to unfulfilled, resetting budgets for media buys associated with the bids, adjusting campaign goals to pre-auction levels, and so forth.

The response from the provider can also be used to determine offers that are accepted. For accepted offers, ad manager module 128 can be configured to cause advertisements associated with the offers to be placed with the corresponding avails. Placing of the ads with avails causes the advertisements to be shown in conjunction with corresponding content that is distributed by a network operator to one or more clients. Thus, for accepted offers, ads corresponding to the accepted offers are displayed at the clients when corresponding content is rendered. Optionally, when offers are accepted, the price for future offers to the provider can be lowered to determine an optimal price that still meets the provider's expectations. In particular, iterative reduction of the price can occur until offers are rejected by the provider. In this manner, an optimal price can be identified. Finding the optimal price can enable advertiser's costs to be decreased and/or a profit margin for the ad management system to be increased.

Step 310 performs yield analysis. The yield analysis can be based at least in part upon the response obtained in step 308. In general, the yield analysis determines the how effectively the submitted offers were allocated. The yield analysis can be employed to set-up subsequent iterations. Accordingly, as part of the yield analysis step 312 can compute one or more yield parameters for the projection model based on the response obtained in step 308. Then, step 314 updates the projection model in accordance with the one or more parameters that are computed.

In performing the yield analysis, analytics module 136 can reference the reject codes to understand why certain offers were accepted or rejected. Analytics module 136 can also reference data regarding the prices, durations, and other characteristics of offers that are accepted and rejected, as well a characteristics and constraints associated with actual avails from the provider. This information can be used to update pricing, availability (e.g., inventory), and other yield parameters 140 that are incorporated into the projection model used to make projections. A variety of yield parameters 140 are contemplated as noted previously in relation to FIG. 2.

Consider now a few examples of how yield analysis can be used to iteratively update a projection model used to derive projections for avails. For example, yield analysis may indicate that a particular provider rarely has sixty second spots available. Accordingly, an availability parameter for the provider can be updated accordingly to reflect a low probability for sixty second spots. In another example, pricing feedback for a certain program may indicate that offers are often rejected for having too low of a price. Accordingly, a pricing parameter for the program can be updated to reflect a higher price for the program. In yet another example, when offers are generally accepted by a provider for a particular time slot at a given price, then yield parameters can reflect an expectation that the particular price/availability combination for the slot will be available for future projections. On the other hand, if a provider provides responses indicating that they do not have any inventory of avails having certain characteristics, yield parameters can be adjusted to remove avails of this particular kind from the projection model for the provider.

When the yield analysis has been performed, procedure 300 can proceed at step 316 to perform the next iteration. In particular, procedure 300 can return to step 302, and steps 302 to 310 can be repeated iteratively for another allocation of avails (e.g., another bid allocation) using the updated projections. In particular, feedback of the kind just described in the preceding examples can be encoded by the analytics module 136 using the various yield parameters 140. The projection module 134 can then use the yield parameters 140 to update the projection model accordingly for each iteration. In an example in which iterations are performed daily, projections are made each day and offers that are determined based on the projections can be submitted to a provider to allocate avails that the provider has for the next day. Then, yield analysis for the day can be performed based on which offers are accepted and rejected by the provider. The projection model is updated based on the yield analysis for the day and the process can be repeated for the next day. One or more such iterations can occur in this manner for each of a plurality of providers on a daily basis as in the above example and/or for other time intervals as discussed previously.

Having considered various embodiments, procedures, and examples related to demand driven avails, consider now a discussion of an example system that can be employed to implement one or more embodiments.

Example System

FIG. 4 illustrates an example system generally at 400 that includes an example computing device 402 that is representative of one or more such computing devices that can implement the various embodiments described above. The computing device 402 may be, for example, a server of a network operator 102 or content provider 108 of FIG. 1, a device associated with the client 104 or advertiser 106, and/or any other suitable computing device or computing system.

The example computing device 402 includes one or more processors 404 or processing units, one or more memory and/or storage components 406, one or more input/output (I/O) interfaces 408 for input/output (I/O) devices, and a bus 410 that allows the various components and devices to communicate one to another. The bus 410 represents one or more of several types of bus structures, including a memory bus or memory controller, a peripheral bus, an accelerated graphics port, and a processor or local bus using any of a variety of bus architectures. The bus 410 can include wired and/or wireless buses.

The memory/storage component 406 represents one or more computer storage media. The memory/storage component 406 may include volatile media (such as random access memory (RAM)) and/or nonvolatile media (such as read only memory (ROM), Flash memory, optical disks, magnetic disks, and so forth). The memory/storage component 406 may include fixed media (e.g., RAM, ROM, a fixed hard drive, etc.) as well as removable media (e.g., a Flash memory drive, a removable hard drive, an optical disk, and so forth).

The one or more input/output interfaces 408 allow a user to enter commands and information to computing device 402, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may comprise “computer-readable storage media.”

Software or program modules, including the ad manger module 128, projection module 134, analytics module 136, communication module 124, and other program modules, may be embodied as one or more instructions stored on computer-readable storage media. The computing device 402 may be configured to implement particular functions corresponding to the software or program modules stored on computer-readable storage media. Such instructions may be executable by one or more articles of manufacture (for example, one or more computing devices 402, and/or processors 404) to implement techniques for demand driven avails, as well as other techniques. Such techniques include, but are not limited to, the example procedures described herein. Thus, computer-readable storage media may be configured to store instructions that, when executed by one or more devices described herein, cause various techniques for demand driven avails.

The computer-readable storage media includes volatile and non-volatile, removable and non-removable media and/or storage devices implemented in a method or technology suitable for storage of information such as computer readable instructions, data structures, program modules, or other data. Computer-readable storage media can refer to media and/or devices that enable persistent and/or non-transitory storage of information in contrast to mere signal transmission. The computer-readable storage media can include, but is not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

### CONCLUSION

Various embodiments described above enable demand driven allocation of advertisement insertion opportunities, e.g., avails, that are associated with television content or other media entertainment from a provider. In at least some embodiments, projections for an inventory of avails from a provider are obtained using an iterative projection model. Auctions are conducted using the projected inventory to allocate the avails to advertisers using bids from the advertisers. Offers to purchase avails from the providers can be formed based on these auctions and submitted to the provider on behalf of the advertisers. Based on a response from the providers to these offers, yield analysis can be performed to update the projection model to reflect results of the submitted offers. Projections for subsequent iterations can then make use of the updated projection model.

Although aspects of demand driven avails have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter.

What is claimed is:

1. A method comprising:
projecting an inventory of avails from a content provider using an iterative projection model to obtain projected avails;
conducting auctions for projected inventory to match advertisements from advertisers to the projected avails;
submitting offers to purchase avails from the content provider on behalf of the advertisers based on results of the auction; and
updating the projection model to reflect a response from the content provider to submitted offers.

2. A method as described in claim 1, wherein updating the projection model comprises computing one or more yield parameters associated with the projection model based on the response from the content provider.

3. A method as described in claim 2, wherein the yield parameters include parameters indicative of pricing and availability constraints for the projection model.

4. A method as described in claim 3, wherein the yield parameters further include parameters indicative of one or more of time of day constraints, program characteristics, calendar events, special events, viewership constraints, or adjacency constraints.

5. A method as described in claim 1, wherein updating the projection model comprises analyzing one or more reject codes included in the response from the content provider, the one or more reject codes indicative of reasons why a corresponding offer was rejected.

6. A method as described in claim 1, wherein the avails from the content provider are associated with content made available to clients over a network by a network operator.

7. A method as described in claim 1, wherein conducting the auctions comprises matching the projected avails to bids from the advertisers based on placement objectives of the bids and characteristics of the projected avails, the bids corresponding to media buys input by advertisers to place advertisements in conjunction with content distributed by a network operator to clients.

8. A method as described in claim 1, further comprising
determining offers that are accepted by the content provider based on the response from the content provider; and
placing advertisements corresponding to the accepted offers with the avails to cause the advertisements to be shown in conjunction with corresponding content that is distributed by a network operator to one or more clients.

9. A method as described in claim 1, further comprising:
repeating the projecting, conducting, submitting, and updating for one or more iterations using an updated projection model to perform the projecting for each iteration.

10. A method as described in claim 9, wherein the one or more iterations are performed for the content provider at a designated periodic time interval.

11. A method as described in claim 9, wherein the one or more iterations are performed on a daily basis for each of a plurality of content providers to allocate advertisements to avails from the plurality of content providers.

12. A method comprising:
ascertaining projections for inventory of avails from a content provider using a projection model;
conducting auctions to match advertisements to projected inventory;
submitting offers to purchase avails from the content provider based on the auctions;
obtaining a response from the content provider to accept or reject submitted offers; and
performing a yield analysis based on the response from the content provider to update the projection model for subsequent projections.

13. A method as described in claim 12, further comprising:
repeating the ascertaining, conducting, submitting, obtaining, and performing for one or more iterations using an updated projection model for each iteration.

14. A method as described in claim 12, further comprising repeating the ascertaining, conducting, submitting, obtaining, and performing for the content provider on a daily basis to update the projection model each day and allocate advertisements to avails from the content provider that are available the next day.

15. A method as described in claim 12, wherein conducting the auctions comprises matching projected avails to bids from the advertisers based on placement objectives of the bids and characteristics of the projected avails.

16. A method as described in claim 15, further comprising obtaining the bids by:
examining historic data that describes media buys from advertisers for placement of advertisements in conjunction with distributed content; and
projecting the bids based the historic data.

17. One or more computer-readable storage media comprising computer-executable instructions stored thereon that, when executed by one or more components of a computing system, cause the computing system to implement an ad management system configured to perform acts including:
projecting an inventory of avails from a content provider using an iterative projection model to obtain projected avails;
conducting auctions for projected inventory to match advertisements from advertisers to projected avails;
submitting offers to purchase avails from the content provider on behalf of the advertisers based on results of the auction; and
updating the projection model to reflect a response from the provider to the submitted offers for use in one or more subsequent iterations.

18. One or more computer-readable storage media as described in claim 17, wherein the ad management system is further configured to perform the one or more subsequent iterations at a designated periodic time interval.

19. One or more computer-readable storage media as described in claim 17, wherein the ad management system is further configured to perform acts including:
determining offers that are accepted by the content provider based on the response from the content provider;
placing advertisements corresponding to the accepted offers with the avails to cause the advertisements to be displayed when corresponding content distributed by a network operator to one or more clients is rendered by the one or more clients.

20. One or more computer-readable storage media as described in claim 17, wherein the avails comprise opportunities to insert one or more ads within content distributed by a network operator to one or more clients.
